(19) United States
(12) Patent Application Publication
(10) Pub. No.: US 2020/0122836 A1
(43) Pub. Date: Apr. 23, 2020

(54) SERVING CART FOR A PASSENGER CABIN

(71) Applicant: AIRBUS OPERATIONS GMBH, Hamburg (DE)

(72) Inventor: Guillermo CARMONA-PUGA, Hamburg (DE)

(21) Appl. No.: 16/659,837

(22) Filed: Oct. 22, 2019

(30) Foreign Application Priority Data
Oct. 22, 2018 (DE) 10 2018 008 316.1

(51) Int. Cl. B64D 11/00; B64D 11/04; A47B 31/06

(52) U.S. Cl. CPC B64D 11/0007; B64D 11/04; A47B 2031/002; B62B 2202/67; A47B 31/06

(57) ABSTRACT

A serving cart for a passenger cabin, especially for serving of passengers in transport vehicles such as airplanes. The serving cart includes a receiving space for catering units as well as at least one access opening to the receiving space. The receiving space is enclosed by a housing and the housing includes side walls, a top plate and a bottom plate. On the bottom plate there are lockable rollers making it possible to move the serving cart within the lengthwise aisle of the passenger cabin. In order to improve the working conditions of the flight attendants, it is possible to reach the catering units being handed out to the passengers through the top plate of the housing, which has for this purpose at least one access opening to the receiving space.

### CROSS-REFERENCE TO RELATED APPLICATION

This application claims priority to German Patent Application No. 10 2018 008 316.1 filed Oct. 22, 2018, the entire disclosure of which is incorporated by reference herein.

### TECHNICAL FIELD

The disclosure herein relates to a serving cart for a passenger cabin, especially for serving in transport vehicles such as airplanes, railways, and elsewhere, having a receiving space for catering to passengers as well as at least one access opening to the receiving space.

### BACKGROUND

In the field of aviation, movable containers or serving carts are in use for the onboard gastronomy, being known as trolleys. They are used, especially on-board passenger airplanes, to transport meals, beverages, and other products for sale. Trolleys for airplanes are designed to fit in the relatively cramped galleys of the airplanes.

From DE 43 08 144 C1 for example there is known a serving cart for passengers, comprising a door opening toward the front to accommodate meals inside the receiving space and having receiving levels provided inside the receiving space for trays. Usually rail elements are provided for this on the side walls of the serving cart, allowing the trays to be shoved in on several levels within the receiving space.

Furthermore, there is known from EP 0066547 A2 a serving cart on brakable rollers for use in an aircraft cabin. Here, there is provided a substantially plastic housing, enclosing a receiving space for the catering items. The housing comprises protrusions serving for example to accommodate joints or hinges and closure devices and the like. Furthermore, the housing comprises on the interior especially horizontally running projections/rails to receive trays. On the underside of the housing there are provided, in known manner, rollers which can swivel about a vertical axis. In the closed position, a door closes off the receiving space. The door is provided on a narrow side of the cuboidal trolley, since when the serving cart is moved through the narrow airplane passageways the broad side walls of the serving cart are not accessible to the flight attendants. For the handing out of the prepared meals, which are usually arranged on a tray, the flight attendants must pull out the tray from the receiving space and then remove it. Due to the many trays arranged one above another and the arrangement of the receiving space in the serving cart, which is only accessible from the front when the flight attendant bends over or squats down, the handing out of the trays to the passengers is time-consuming and not ergonomically favorable.

Hence, the problem which the disclosure herein proposes to solve is to enable an ergonomic access to the receiving space of the serving cart and thus to improve the working conditions for the flight attendants. A further problem of the disclosure herein is to disclose a serving cart for a passenger cabin which provides an optimized placement of the trays in the receiving space of the serving cart.

### SUMMARY

The problems can be solved by a serving cart disclosed herein. Advantageous modifications and embodiments are disclosed herein.

A serving cart for a passenger cabin is proposed, especially for the serving of passengers in transport vehicles such as airplanes, railways, and elsewhere. The serving cart comprises or consists substantially of a receiving space for a plurality of catering units as well as at least one access opening to the receiving space. The receiving space is enclosed by a housing and the housing comprises side walls, a top plate and a bottom plate. On the bottom plate there are arranged lockable rollers, making possible a moving of the serving cart within the lengthwise aisle of the passenger cabin. In order to improve the working conditions of the flight attendants, according to the disclosure herein it is possible to reach the catering units being handed out to the passengers through the top plate of the housing. For this, the top plate is provided with at least one access opening to the receiving space. The catering units are movable substantially in the vertical direction for their removal from the receiving space.

Hence, an ergonomic access to the receiving space of the serving cart is made possible, which makes possible a much easier handing out of catering units. The catering units are usually trays with food portions arranged on them. The food portions may be of various kinds. For example, it is customary to offer several alternatives, such as meat dishes or also vegetarian or vegan food. Thus, with an access through access openings from above to the receiving space, the working conditions for the flight attendants are improved, since a bending down or a kneeling down to reach the trays in the bottommost compartments is avoided.

The serving cart in one preferred embodiment comprises a dispensing system which is arranged in the receiving space and provided with side guideways for the stacking and dispensing of catering units in the vertical direction to the access opening. Thus, an optimized placement of the catering units or the trays in the receiving space of the serving cart can be achieved, which supports a quick handing out of the food to the passengers.

For this, the dispensing system comprises a receiving plate, which is movable in the vertical direction by spring force or an electromechanical actuator. The catering units can be stacked on the receiving plate, bounded by the side guideways. Thanks to the vertical movement of the receiving plate, one catering unit is always easily accessible in the region of the access opening in the top plate and may thus be taken out from the serving cart by one person, with no problems.

For the movement of the receiving plate in the vertical axis in the direction of the access opening, adjusting elements are arranged preferably on the outer region of the receiving plate, acting in the vertical axis. These may be, for example, helical springs, pneumatic springs, linear actuators or threaded spindles or also threaded rods with spindle drive. An important function of the adjusting elements is the uniform movement of the receiving plate and a locking or positioning upon reaching a particular level making it possible to remove the catering unit from the access opening.

In another preferred embodiment, a control and driving unit is provided for controlling the driving of the receiving plate according to an input signal. The receiving plate preferably always moves in steps by the adjusting elements with a length of movement corresponding to the height of a catering unit. This may be the height of the tray with corresponding food items. The receiving plate then moves each time in the vertical direction by a tray height for the dispensing of the food and the uppermost unit of the stacked catering units protrudes from the access opening or is flush with the plane of the top plate and can be easily removed. For the filling of the receiving space, various steps can be taken. Thus, the receiving plate may also be moved downwards in steps (each time for the height of a tray) or even an entire stack of catering units can be placed on the fully lowered receiving plate in one filling process.

The movement of the adjusting elements can be manually triggered. For example, a switch is provided for the upward and downward movement with a triggering for an upward movement or a downward movement.

In combination or alternatively, the triggering of the movement of the receiving plate can be supported automatically. For example, tray detection sensors may be arranged in the area of the plane of the access opening in the top plate. These detect the position of the uppermost tray and when a tray is removed or loaded on.

In another preferred embodiment, the top plate is provided with at least two access openings, wherein an associated dispensing system belongs to the corresponding access opening. This ensures that different food choices of passengers can also be taken into account and the catering units of a dispensing system may contain a particular food and can be removed through the first access opening and also a second alternative food is accessible through the second access opening and making use of the second dispensing system. This is conceivable for a half-size trolley, for example. In a full-size trolley as many as four different catering units are conceivable in direct access through four access openings.

Thus, the trays in the receiving space of the serving cart are optimally arranged and the flight attendants can remove the catering units with no additional effort of searching for a special food.

The access openings are preferably closable with a cover plate. This cover plate may comprise the usual insulating materials for a serving cart, in order to also adequately insulate and keep warm the heated food units. The cover plate may be designed such that each access opening is provided with its own cover element. It is also possible to provide a cover element which is assigned to two access openings and which opens up the access for one opening each time.

The cover elements are movable and may also be telescopically pushed together. As an alternative embodiment, the cover elements may also be foldable. As a further alternative form, striplike cover elements are also possible, which are retractable in the manner of a roller blind.

### BRIEF DESCRIPTION OF THE DRAWINGS

Further features, benefits and application possibilities of the disclosure herein will emerge from the following description of the exemplary embodiments and the figures. All the features described and/or graphically depicted form the subject matter of the disclosure herein in themselves and in any given combination, even independently of their statement in the individual claims or their referral to these claims. Furthermore, the same reference numbers in the figures stand for the same or similar objects.

FIG. 1 shows a serving cart in a perspective view.

FIG. 2 shows a serving cart in schematic representation in a first embodiment of the dispensing system.

FIG. 3 shows a serving cart in schematic representation in a second embodiment of the dispensing system.

FIG. 4 shows in a top view the top plate of a trolley according to the disclosure herein.

FIG. 5 shows in a schematic representation the top view of a commercial airplane.

### DETAILED DESCRIPTION

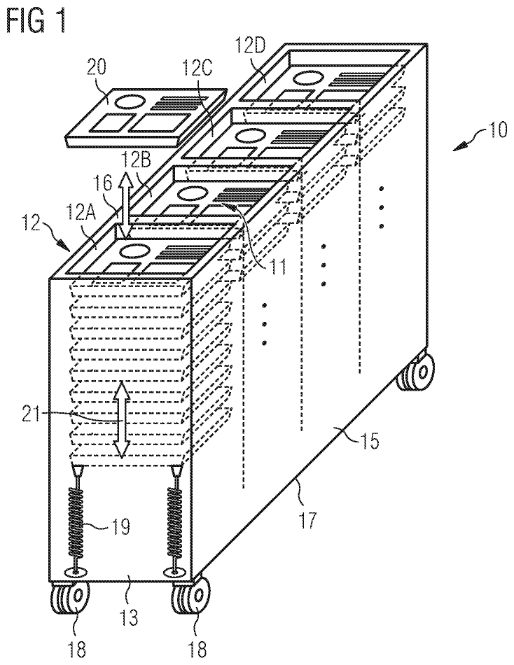

FIG. 1 shows a serving cart 10 in perspective view. Such a serving cart 10, also called a trolley, is proposed for a passenger cabin, especially for the serving of passengers and handing out of catering units in transport vehicles such as airplanes, railways, and elsewhere. The serving cart 10 comprises or consists substantially of a receiving space 11 for a plurality of catering units 20.

The receiving space 11 is enclosed by a housing 13. The housing 13 comprises side walls 15, a top plate 16 and a bottom plate 17. On the bottom plate 17 there are arranged lockable rollers 18, making possible a moving of the serving cart 10 within the lengthwise aisle of a passenger cabin as well as a locking of the serving cart when catering units 20 are removed. The top plate 16 of the housing 13 comprises at least one access opening 12 to the receiving space 11. In this preferred embodiment there is shown a serving cart 10 having the dimensions of a typical familiar airline full-size trolley (ATLAS or KSSU standard) and in which four access openings 12A, 12B, 12C and 12D are devised in the top plate 16. The catering units 20 are moved substantially in the vertical direction for their removal from the receiving space 11, as indicated by the direction arrow 21. For this, at least one dispensing system 19 is provided, which transports the catering units 20 to the access opening 12 in the top plate 16. The catering units 20 can be easily removed in the area of the individual access openings 12A, 12B, 12C or 12D.

Preferably, the use of such a serving cart 10 is provided in a passenger cabin 50 of a commercial airplane 100. FIG. 5 shows a top view of a commercial airplane. The passenger cabin 50 and the airplane lengthwise aisle 51 are indicated in schematic manner. They are designed suitably for the relatively cramped galleys, also known as the onboard kitchen, for airplanes. A movement of the serving cart 10 is provided within the lengthwise aisle 51 of a passenger cabin 50 and the flight attendants can remove the catering unit 20 chosen by the passenger in the corresponding seat row.

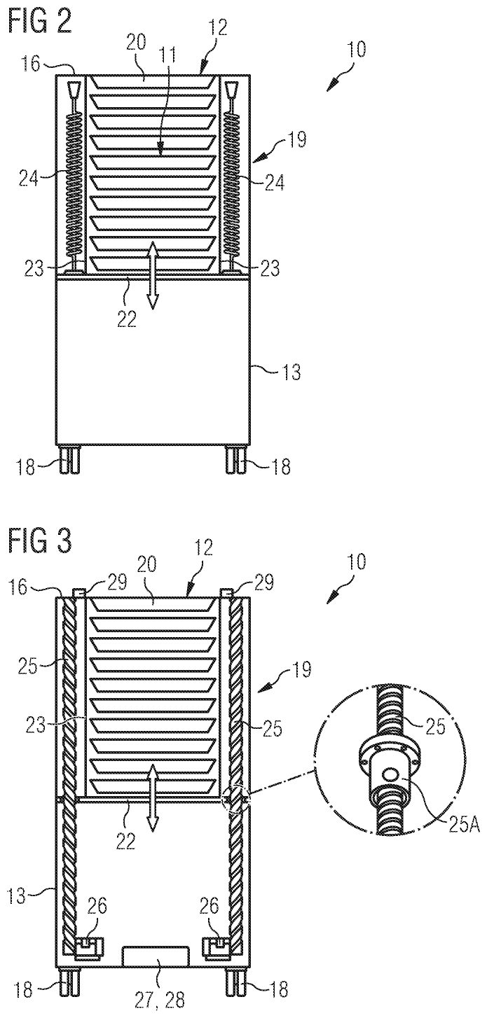

FIG. 2 shows a first preferred embodiment of a serving cart 10 in a schematic view from the front. In the receiving space 11 there can be seen the plurality of catering units 20, arranged one above another. This stacked arrangement of the catering units 20 is done on a receiving plate 22, which is situated inside the receiving space 11 and forms part of the dispensing system 19. The receiving plate 22 is moved in the vertical direction by spring force. The catering units 20 can be stacked on the receiving plate 22, bounded by side guideways 23. Thanks to the vertical movement of the receiving plate 22, one catering unit 20 is always easily accessible in the region of the access opening 12 in the top plate 16 and may thus be taken out from the serving cart by one person, with no problems.

For the movement of the receiving plate 22 in the vertical axis in the direction of the access opening 12, adjusting elements 24 acting in the vertical axis are arranged preferably on the outer region of the receiving plate 22 as a further component of the dispensing system 19. Preferably, the adjusting elements 24 are arranged at the four corners in the case of a substantially rectangular receiving plate 22. However, at least one force-transmitting adjusting element 24 is necessary for each receiving plate 22. These may be, for example, spring actuators 24, such as helical springs or pneumatic springs. An important function of the adjusting elements 24 is the uniform movement of the receiving plate 22 and a locking or positioning upon reaching a particular level. This may be accomplished for the adjusting elements 24 for example by manually operated locks, hooks, detent elements. Thanks to the predetermined height of the catering units 20, the travel path or the movement height of the adjusting elements 24 can also be set in advance.

FIG. 3 shows a second preferred embodiment of a serving cart 10 in a schematic view from the front. In the receiving space 11 there can be seen the plurality of catering units 20, arranged one above another. This stacked arrangement of the catering units 20 is done, as already shown in the first embodiment, on the receiving plate 22, which is situated inside the receiving space 11 and forms part of the dispensing system 19. The receiving plate 22 is moved in the vertical direction by linear actuators 25. These may be threaded spindles or drive screws or also threaded rods with spindle drive. The threaded spindles or threaded rods 25 are driven for this purpose by the preferably electric drive unit. The catering units 20 can be stacked on the receiving plate 22, bounded by side guideways 23. Thanks to the vertical movement of the receiving plate 22, one catering unit 20 is always easily accessible in the region of the access opening 12 in the top plate 16 and may thus be taken out from the serving cart by one person, with no problems.

For the movement of the receiving plate 22 in the vertical axis in the direction of the access opening 12, linear actuators 25 are arranged as a further component of the dispensing system 19 preferably at the outer region of the receiving plate 22 and acting in the vertical axis. Preferably, the linear actuators 25 are arranged at the four corners for a substantially rectangular receiving plate 22. However, at least one force-transmitting linear actuator 25 is necessary for each receiving plate 22. These may be threaded spindles or drive screws or also threaded rods. The respective threaded nut 25A is firmly connected to the receiving plate 22. The threaded spindles or threaded rods 25 are driven via the spindle drive 26, preferably an electric drive unit. This ensures the uniform movement of the receiving plate 22 upon activating the spindle drive 26.

A power supply 27, preferably a battery, is provided to energize the drive unit 26. Furthermore, there is provided in the serving cart 10 a control unit 28 for controlling the drive unit of the receiving plate 22 according to an input signal. Thus, it may be provided that the drive unit always moves the receiving plate 22 in the vertical direction in steps with a movement length corresponding to the height of a catering unit. This may be the tray height of the catering unit with corresponding food items. In an alternative embodiment, an actuating of the drive unit 26 may be manual, for example, by a switch (not shown), which controls the up or down movement of the receiving plate 22. A sensor-assisted triggering of the movement of the receiving plate 22 is provided in the exemplary embodiment shown. For example, tray detection sensors 29 may be arranged in the area of the plane of the access opening 12 in the top plate 16. These detect the position of the uppermost catering unit 20. Then, when a catering unit 20 has been removed or loaded on, the drive unit 26 is actuated and the linear actuators 25 move the receiving plate 22 accordingly.

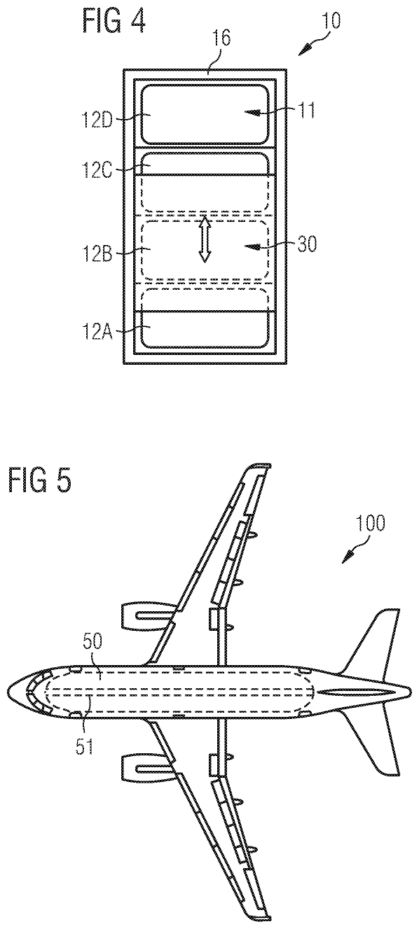

FIG. 4 shows in a top view the top plate 16 of a serving cart 10 according to the disclosure herein. This preferred embodiment shows a serving cart 10 having the dimensions of a customary familiar airline full-size trolley (ATLAS or KSSU standard) in which four access openings 12A, 12B, 12C and 12D are devised in the top plate 16. However, the dimensions of a half-size trolley may likewise be used, in which case then the number of the access openings to the receiving space 11 is then limited to two.

The access openings 12A, 12B, 12C and 12D may be closed preferably with a cover plate 30. This cover plate 30 may have the usual insulating materials for a serving cart 10, in order to adequately insulate and keep warm the heated food units/catering units 20. The cover plate 30 may be configured such that each access opening 12 has its own cover element, which may then overlap when displaced. It is also possible to provide one cover element 30 (shown in FIG. 4) which is assigned to two access openings and which frees up the access to two openings each time. For example, it is shown how the cover plate 30 frees up the access opening 12D and 12 C is partly freed up. Thus, a displacement of the cover plate 30 can provide different accesses to the catering units 20 in the four access openings 12A, 12B, 12C and 12 D. The displacement of the cover plate 30 or also of individual cover elements occurs preferably in linear guides, which are provided in a plane above the top plate.

FIG. 5 shows a commercial airplane in a top view. The passenger cabin 50 and the airplane lengthwise aisle 51 are in schematic fashion. These are designed suitably for the relatively cramped galleys, also known as onboard kitchens, for airplanes. Trolleys or serving carts can be kept and filled in the onboard kitchens. These are then moved in the airplane lengthwise aisle for handing out of the catering.

It should be pointed out in addition that “comprising” does not rule out any other elements or steps, and “a” or “an” does not rule out a plurality. Moreover, it should be pointed out that features described in reference to one of the above exemplary embodiments can also be used in combination with other features or other exemplary embodiments described above. Reference numbers in the claims are not meant as a limitation.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMBERS

10 Serving cart
11 Receiving space
12 Access opening
13 Housing
14 Closing device
15 Side walls
16 Top plate
17 Bottom plate
18 Rollers
19 Dispensing system
20 Catering units
21 Direction arrow
22 Receiving plate
23 Side guides
24 Spring actuators/adjusting elements
25 Threaded spindle/adjusting elements
25A Threaded nut
26 Drive unit
27 Power supply/battery
28 Control unit
29 Sensor
30 Cover plate
50 Passenger cabin
51 Airplane lengthwise aisle
100 Passenger airplane

1. A serving cart for a passenger cabin of a transport vehicle, the serving cart comprising:
a receiving space for a plurality of catering units as well as at least one access opening to the receiving space, wherein the receiving space is enclosed by a housing;
the housing comprising side walls, a top plate and a bottom plate, on which there are lockable rollers;
the top plate of the housing comprising at least one of the at least one access opening to the receiving space; and
wherein the catering units are movable substantially in a vertical direction for their removal from the receiving space.

2. The serving cart according to claim 1, comprising at least one dispensing system for stacking and dispensing of catering units in a vertical direction to the at least one access opening.

3. The serving cart according to claim 1, wherein the dispensing system comprises a receiving plate, which is movable in the vertical direction by spring force or linear actuators.

4. The serving cart according to claim 3, wherein adjusting elements are on an outer region of the receiving plate, configured to act in a vertical axis.

5. The serving cart according to claim 3, comprising a control and driving unit for controlling movement of the receiving plate according to an input signal.

6. The serving cart according to claim 3, comprising a switch for upward and downward movement with a triggering for an upward movement or a downward movement of the receiving plate.

7. The serving cart according to claim 3, wherein detection sensors are in an area of a plane of the access opening in the top plate for triggering of movement of the receiving plate.

8. The serving cart according to claim 1, wherein the top plate comprises at least two access openings, wherein an associated dispensing system is provided for the corresponding access opening.

9. The serving cart according to claim 1, comprising a cover plate for closing and/or opening of the at least one access opening.

10. The serving cart according to claim 9, wherein the cover plate is above the top plate and is movable in linear guideways.
